(19) United States
(12) Patent Application Publication
(10) Pub. No.: US 2013/0320093 A1
(43) Pub. Date: Dec. 5, 2013

(54) SUBSCRIBER IDENTITY MODULE AND SUBSCRIBER IDENTITY MODULE WITH ANTENNA

(71) Applicants: Hsin-Lung Lin, Hsinchu (TW); Chia-Yu Pan, Taichung (TW)

(72) Inventors: Hsin-Lung Lin, Hsinchu (TW); Chia-Yu Pan, Taichung (TW)

(73) Assignee: SMART APPROACH CO., LTD., Hsinchu (TW)

(21) Appl. No.: 13/482,858

(22) Filed: May 29, 2012

(51) Int. Cl. G06K 19/06

(52) U.S. Cl. 235/487

(57) ABSTRACT

A subscriber identity module includes a base, an identification unit and an identification chip. The base has a first accommodating area and a second accommodating area. The identification unit is configured in the first area, and the identification unit is exposed on a first surface of the base. The identification chip is configured in the second accommodating area and between the first surface and the second surface of the base, wherein the first surface is opposite to the second surface.

### BACKGROUND

1. Technical Field

The present disclosure relates to a subscriber identity module (SIM), and more particularly to a SIM with antenna.

2. Related Art

A SIM is a smart card capable of storing data and being accessed based on an identification command. If the identification command is wrong, the SIM card rejects the accessing of data from a user. That is, a user must input a right identification command to use the data stored in the SIM. For example, when a SIM card is used in a cell phone, a user must input the correct password to unlock the SIM card and then can use the phone for communications. Therefore, a SIM card can be used as a device for identifying particular users.

With development of wireless communications, manufacturers have combined a SIM card with RFID technology. The RFID technology is a radio communication technology, and it is composed of a reader, a transponder, and middleware & system integration. Therefore, a SIM card integrated with the RFID technology can be functioned like a RFID tag.

After finishing manufacturing a SIM, a base is used for protecting the chip of the SIM and an RFID antenna is formed on a soft board of the SIM. Thus, when the SIM is provided with the RFID antenna, a RFID chip is disposed between the soft board and the base. However, this configuration may increase the thickness of the soft board and the base.

### SUMMARY

In one aspect, a subscriber identity module comprises a base, an identification unit and an identification chip. The base has a first accommodating area and a second accommodating area. The identification unit is configured in the first area, and the identification unit is exposed by a first surface of the base. The identification chip is configured in the second accommodating area and between the first surface and a second surface opposite to the first surface.

In another aspect, a subscriber identity module with an antenna comprises: a soft board, an antenna coil, a base, an identification unit, and an identification chip. The antenna coil is disposed on one end of the soft board. The base is attached to the soft board and disposed on the other end of the soft board. The base has a first accommodating area and a second accommodating area. The identification unit is configured in the first accommodating area and exposed on a first surface of the base. The identification unit is electrically connected to the soft board through metal protrusions on the soft board. Furthermore, the identification chip is configured in the second accommodating area and between the first surface and a second surface of the base, wherein the first surface and the second surface are opposite to each other.

### BRIEF DESCRIPTION OF THE DRAWINGS

The present disclosure will become more fully understood from the detailed description given herein below for illustration only, and thus are not limitative of the present disclosure, and wherein:

FIG. 1 is a top view of a SIM with an antenna according to a first embodiment of the present disclosure;

FIG. 2 is a side view of a SIM with an antenna according to the first embodiment of the present disclosure; and

FIG. 3 is an exploded view of a SIM with antenna according to a second embodiment of the present disclosure.

### DETAILED DESCRIPTION

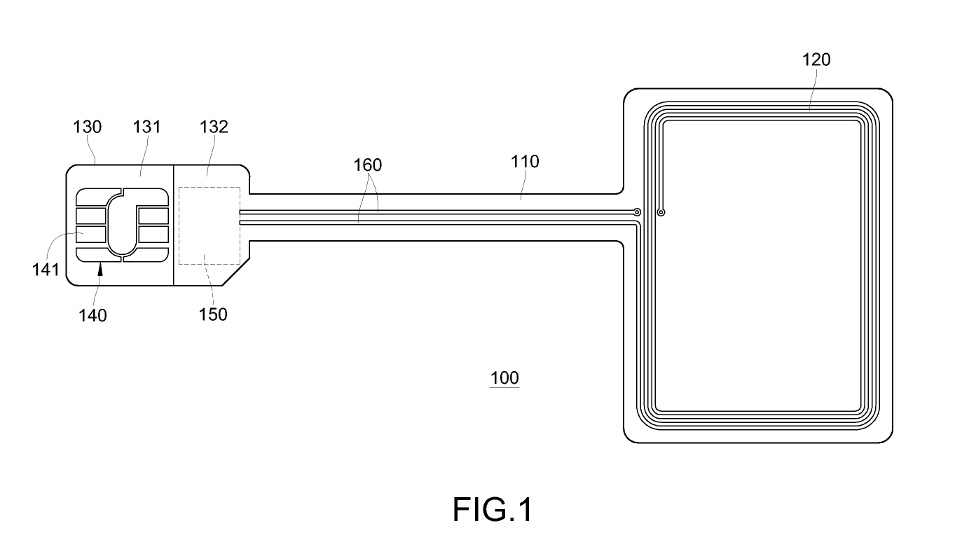

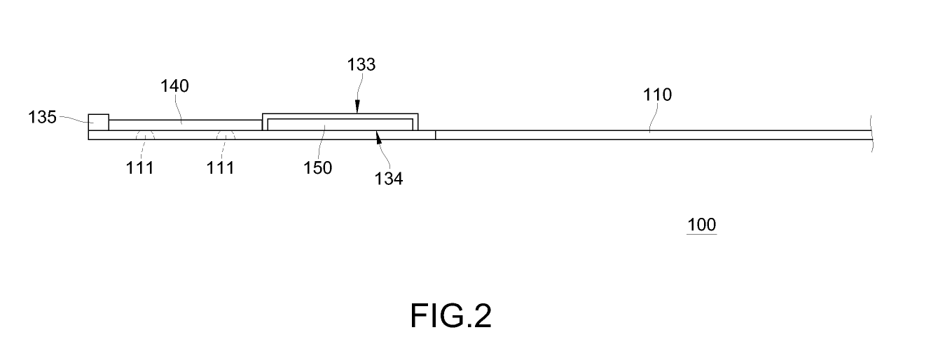

FIG. 1 and FIG. 2 is a top view and a side view of a SIM with an antenna according to a first embodiment of the present disclosure. Referring to FIGS. 1-2, in this embodiment, the SIM 100 is adapted to be set in a cell phone for replacing the conventional SIM. Furthermore, the SIM 100 has functions of Radio Frequency Identity (REID) or the Near Field Communication (NFC).

The SIM 100 includes a soft board 110, an antenna coil 120, a base 130, an identification unit 140, and an identification chip 150. The soft board 110 may be a flexible substrate, for example, a FPC (flexible printed circuit) board.

The antenna coil 120 is configured on one end of the soft board 110, and it can be printed on the soft board 110. However, the disclosure is not limited this way. For example, the antenna coil 120 may be a radio-frequency antenna or a near field communication antenna.

The base 130 is attached to the other end of the soft board 110, opposite to the antenna coil 120. In other words, the base 130 and the antenna coil 120 are disposed on the two ends of the soft board 110 respectively. The base 130 includes a first accommodating area 131 and a second accommodating area 132 which are used to accommodate different objects. In this embodiment, the base 130 can be bonded to the soft board 110 by way of thermo-compression or agglutination. However, the disclosure is not limited this way.

The identification unit 140 is provided in the first accommodating area 131 and is exposed on the first surface 133 of the base 130. In other words, the identification unit 140 is not covered by the first surface 133 of the base 130. The identification unit 140 comprises a plurality of pads 141, which are used for example as eight basic pads in the SIM for a cell phone. The connection points for the pads 141 may correspond to the electric connection points in the card holder of the SIM in the cell phone.

In this embodiment, the identification unit 140 is electrically connected to the soft board 110. Specifically, the soft board 110 has a plurality of metal pads 111 (for example, 8 metal pads). Furthermore, each of the metal pads 111 is set corresponding to each pad 141 of the identification unit 140 (i.e., in a one to one manner). The plurality of metal pads 111 are disposed on the second surface 134 of the base 130, which is facing to the first surface 133. When the soft board 110 is bonded to the base 130, the identification unit 140 is electrically connected to the soft board 110 by the metal pads 111. In addition, when the SIM 100 is equipped in a cell phone, the identification unit 140 is electrically contacted to the electric connection points in the card holders of the cell phone by the second surface 134 of the base 130 and the metal pads 111 on the soft board 110. In this case, the identification unit 140 can be electrically connected to the cell phone.

Furthermore, the base 130 may be made of plastic or iron materials so as to correctly control the configuration position of the identification unit 140 and improve the structural strength of the base 130. The base 130 further includes a fastener 135 provided in the first accommodating area 131. The fastener 135 is used to fasten the identification unit 140 in the first accommodating area 131.

The identification chip 150 is configured in the second accommodating area 132 and between the first surface 133 and the second surface 134. Furthermore, the identification chip 150 is electrically connected to the identification unit 140 and the antenna coil 120 through the connecting line 160. In this embodiment, the identification chip 150 may be disposed on the soft board 110 by Chip on Board (COB) process or Chip in Film (COF) process, but the disclosure is not limited this way. In this embodiment, the identification chip 150 can be disposed between the first surface 133 and the second surface 134 by performing an adhesive-filling process to the second accommodating area 132. That is, the identification chip 150 is covered by the first surface 133 of the base 130.

Additionally, the SIM 100 further comprises a connecting line 160, which is disposed on the soft board 110 and between the antenna coil 120 and the identification chip 150, so that the antenna coil 120 can be electrically connected to the identification chip 150 by the connecting line 160. The antenna coil 120 can be used to receive a first radio signal sent by a RFID reader and then convert the first radio signal into a first signal current. Then, the first signal current can be transmitted to the identification chip 150 through the connecting line 160. In the other hand, the antenna coil 120 can convert a second signal current transmitted from the identification chip 150 to be another radio signal and wirelessly send the radio signal to the RFID reader.

In this embodiment, the identification unit 140 may be for example a Micro SIM, and the identification chip 150 may be for example a RFID chip. Based on the above configuration, the thickness of the SIM 100 can be reduced and thus facilitate the usage of the SIM 100.

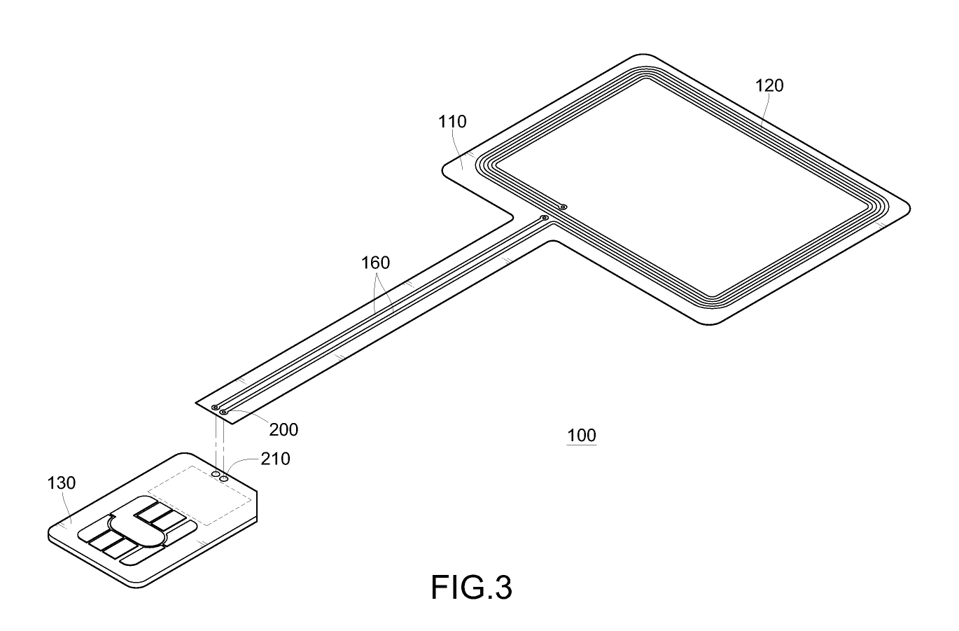

FIG. 3 is an exploded view of a SIM with antenna according to a second embodiment of the present disclosure. In this embodiment, the SIM 100 further includes an electrical connector 200, which is disposed on one end of the soft board 110 while the antenna coil 120 is disposed on the other end of the soft board 110. The antenna coil 120 is capable of being electrically connected to the electrical connector 200 through the connecting line 160. In this embodiment, the electrical connector 200 is two metal protrusions.

In this embodiment, the base 130 comprises an electrical socket 210 electrically connected to the identification chip 150. For example, the electrical socket 210 may comprise two metal pads. In this case, the identification chip 150 can be electrically connected to the antenna coil 120 when the electrical connector 200 is inserted into the electric socket 210. Specifically, when the base 130 is equipped to the soft board 110, the metal protrusions (i.e., the electrical connector 200) on the soft board 110 should be inserted into the two metal pads (i.e., the electric socket 210) on the base 130. Then, the base 130 is bonded with the soft board 110 by way of double-sided adhesive tape, thermo compression or welding. Therefore, the SIM 100 in this embodiment may have the same effect as that the first embodiment.

In another embodiment, the electrical connector 200 may be set on the cell phone, for example, on the card holder of the base 130 (i.e., the SIM). The position of the electrical connector 200 corresponds to the position of the two metal pads (i.e., the electric socket 210). In this case, when the base 130 is inserted into the card holder, the base 130 is capable of being directly connected to the soft board 110 without bonding the base 130 to the soft board 110 by way of thermo compression or welding. Therefore, the usage convenience of the SIM can be improved.

Accordingly, according to the embodiments of the present disclosure, the SIM and the SIM with antenna comprises the first and second accommodating areas, in which the identification unit and the identification chip are disposed respectively. Furthermore, the identification unit is exposed on the first surface of the base. The identification chip is formed between the first surface and the second surface of the base by adhesive-filling process. The position of the identification unit can be correctly controlled by limiting the adhesive area form by the adhesive-filling process. As a result, the thickness of the SIM is reduced, the structural strength of the SIM is improved, and the usage convenience of the SIM is enhanced.

It should be understood that the embodiments disclosed above is not intended to limit the disclosure. Persons skilled in the art would appreciate that various alterations and modifications can be made herein without departing from the spirit and scope of the disclosure as defined by the appended claims.

What is claimed is:

1. A subscriber identity module (SIM), comprising:
a base having a first accommodating area and a second accommodating area;
an identification unit configured in the first accommodating area and being exposed on a first surface of the base; and
an identification chip configured in the second accommodating area and between the first surface and a second surface of the base, wherein the second surface being opposite to the first surface.

2. The subscriber identity module according to claim 1, wherein the base is made of plastic or iron materials.

3. The subscriber identity module according to claim 2, wherein the base further comprising a fastener in the first accommodating area for fastening the identification unit, and the identification chip is configured between the first surface and the second surface by performing an adhesive-filling process on the second accommodating area.

4. The subscriber identity module according to claim 1, wherein the identification unit is a Micro SIM, and the identification chip is a radio frequency identification (RFID) chip.

5. A subscriber identity module (SIM) having an antenna, the subscriber identity module comprising:
a soft board;
an antenna coil disposed on one end of the soft board;
a base attached to the soft board and disposed on the other end of the soft board, wherein the base having a first accommodating area and a second accommodating area;
an identification unit configured in the first accommodating area and exposed on a first surface of the base, wherein the identification unit being configured to be electrically connected to the soft board by metal protrusions on the soft board; and
an identification chip configured in the second accommodating area and between the first surface and a second surface of the base, wherein the first surface and the second surface being opposite to each other, and wherein the identification chip being configured to be electrically connected to the identification unit and the antenna coil.

6. The subscriber identity module according to claim 5, further comprising a connecting line disposed on the soft board and between the identification chip and the antenna coil, so that the antenna coil is capable of being electrically connected to the identification chip and the identification unit.

7. The subscriber identity module according to claim 5, wherein the base is made of plastic or iron materials.

8. The subscriber identity module according to claim 7, wherein the base further comprises a fastener in the first accommodating area for fastening the identification unit, and the identification chip is configured between the first surface and the second surface by performing an adhesive-filling process on the second accommodating area.

9. The subscriber identity module according to claim 5, wherein the identification unit is a Micro SIM, and the identification chip is a Radio Frequency

10. The subscriber identity module according to claim 5, wherein the antenna coil is a radio-frequency antenna or a near field communication antenna.
